(19) United States
(12) Patent Application Publication
(10) Pub. No.: US 2013/0249686 A1
(43) Pub. Date: Sep. 26, 2013

(54) MONITORING SYSTEM, FLOW RATE MONITOR AND FLOW RATE MONITORING METHOD

(71) Applicant: HON HAI PRECISION INDUSTRY CO., LTD., New Taipei (TW)

(72) Inventor: CHUN-CHIEH CHANG, New Taipei (TW)

(73) Assignee: HON HAI PRECISION INDUSTRY CO., LTD., New Taipei (TW)

(21) Appl. No.: 13/797,801

(22) Filed: Mar. 12, 2013

(30) Foreign Application Priority Data
Mar. 26, 2012 (TW) 101110312

(51) Int. Cl. G08B 21/18

(52) U.S. Cl. CPC G08B 21/182
USPC 340/539.1

(57) ABSTRACT

A monitoring system includes a flow rate monitor and an alarm. The flow rate monitor includes a pendulum, a first storage unit, a monitoring unit, a first control unit, and a wireless transmitting unit. The monitoring unit determines an angle of an angular movement of the pendulum by detecting the angular movement of the pendulum caused by movement of a moving medium, and generates a signal associated therewith. The first control unit generates a warning signal when the angle detected is equal to or larger than an angle threshold value stored in the first storage unit, and controls the wireless transmitting unit to transmit the warning signal to the alarm to perform a warning alarm. A related flow rate monitor and a related method are also provided.

### BACKGROUND

1. Technical Field

The present disclosure relates to a monitoring system, a flow rate monitor and a flow rate monitoring method.

2. Description of the Related Art

Monitoring systems, such as gas alarm systems and air monitoring alarm systems are usually designed as one unit, including an alarm. However, in use, it is more efficient for the detector to be put near a monitored object, and for the alarm to be put where it can be heard clearly by users. If the alarm and the detector are designed as one unit, and the object that needs to be monitored is in an area away from the users there could be a problem hearing the alarm, it may result in inconvenience for the users.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a monitoring system, according to an exemplary embodiment.

FIG. 2 is a diagram block of a flow rate monitor of the monitoring system of FIG. 1.

FIG. 3 is a schematic view of the flow rate monitor of the monitoring system of FIG. 1.

FIG. 4 is a diagram block of an alarm of the monitoring system of FIG. 1.

FIG. 5 is a diagram block of an alarm of the monitoring system of FIG. 1, according to another exemplary embodiment.

FIG. 6 is a flowchart of a flow rate monitoring method, according to an exemplary embodiment.

### DETAILED DESCRIPTION

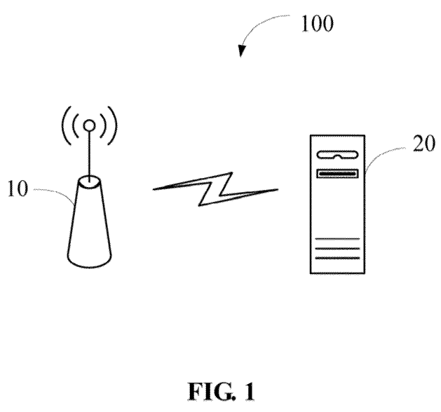

FIG. 1 is an embodiment of a monitoring system 100. The monitoring system 100 includes an alarm 10 and a flow rate monitor 20. The alarm 10 communicates with the flow rate monitor 20 via a wireless network.

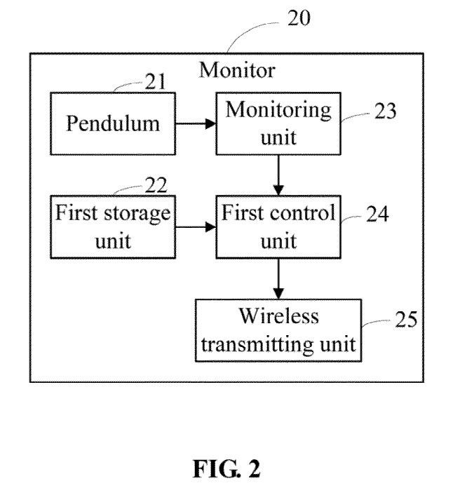

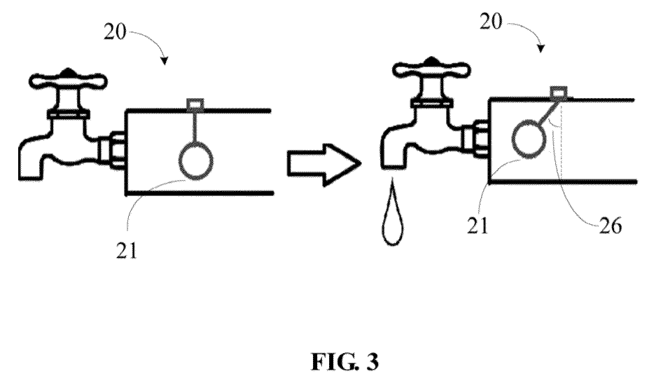

Referring FIGS. 2 and 3, the flow rate monitor 20 includes a pendulum 21, a first storage 22, a monitoring unit 23, a first control unit 24, and a wireless transmitting unit 25. The pendulum 21 is suspended in a moving medium filling in the flow rate monitor 20. The first storage unit 22 stores an angle threshold value. The monitoring unit 23 detects angular movement of the pendulum 21 by movement of the moving medium, senses an angle 26 of the angular movement of the pendulum 21, and generates a signal associated therewith. In the embodiment, the monitoring unit 23 is a gravity sensor.

The first control unit 24 obtains the angle threshold value from the first storage unit 22 in response to the signal generated by the monitoring unit 23, and determines whether the angle 26 detected by the monitoring unit 23 is equal to or larger than the angle threshold value. If the angle detected by the monitoring unit 23 is equal to or larger than the angle threshold value, the first control unit 24 generates a warning signal, and controls the wireless transmitting unit 25 to transmit the warning signal to the alarm 10.

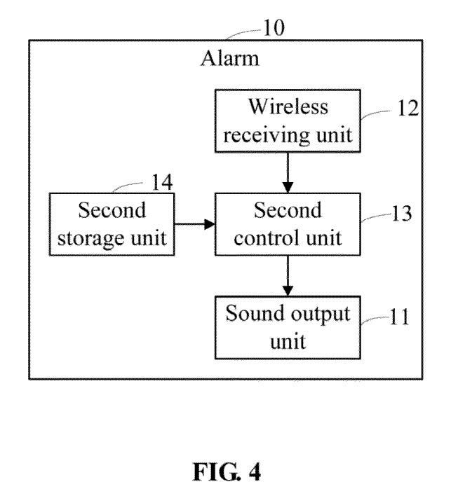

FIG. 4 shows the alarm 10 includes a sound output unit 11, a wireless receiving unit 12, a second control unit 13, and a second storage unit 14. The second storage unit 14 stores a plurality of audio warning files. The wireless receiving unit 12 receives the warning signal transmitted by the wireless transmitting unit 25. The second control unit 13 obtains one of the plurality of warning audio files in response to the warning signal, and controls the sound output unit 11 to play the obtained audio warning file.

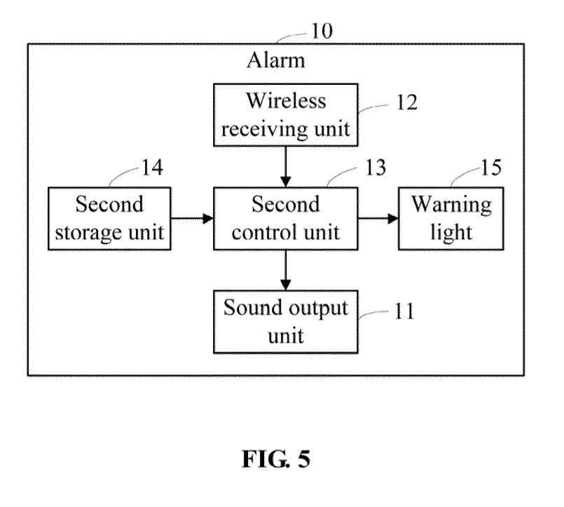

FIG. 5 shows that in an alternative embodiment, the alarm 10 further includes a warning light emitter 15, If the alarm 10 receives the warning signal, the second control unit 13 controls the warning light emitter 15 to emit the warning light in response to the received the warning signal.

In the embodiment, the alarm 10 further includes a button, which can be operated by a user to stop the warning signal. In detail, the button is operated by the user to generate a trigger signal, the second control unit 13 controls the sound output unit 13 to stop playing the audio warning files and/or the warning light emitter 15 to go out.

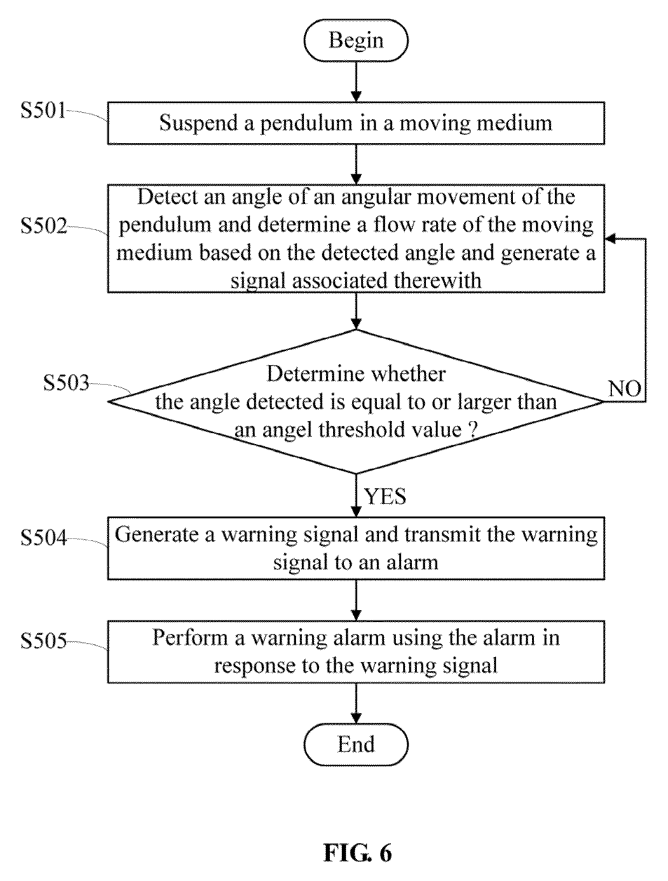

FIG. 6 is a flowchart of a flow rate monitoring method employed by the monitoring system.

In step S501, the pendulum 21 is suspended in a moving medium filling in the flow rate monitor 20.

In step S502, the monitoring unit 23 detects angular movement of the pendulum 21 by movement of the moving medium, senses the angle 26 of the angular movement of the pendulum 21, and generates a signal associated therewith.

In step S503, the first control unit 24 obtains the angle threshold value from the first storage unit 22 in response to the signal generated by the monitoring unit 23, and determines whether the angle 26 detected by the monitoring unit 23 is equal to or larger than the angel threshold value. If yes, the procedure goes to step S504, otherwise, the procedure ends.

In step S504, the first control unit 24 generates the warning signal and controls the wireless transmitting unit 25 to transmit the warning signal to the alarm 10.

In step S505, the wireless receiving unit 12 of the alarm 10 receives the warning signal transmitted by the wireless transmitting unit 25. The second control unit 13 obtains one of the plurality of warning audio files in response to the warning signal, and controls the sound output unit 10 to play the obtained warning audio file.

In the embodiment, the second control unit 13 controls the warning light emitter 15 to emit the warning light in response to the received the warning signal. Then, the button is operated by the user to generate a trigger signal, the second control unit 13 controls the sound output unit 13 to stop playing the warning audio files and/or the warning light emitter 15 to go out.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. A monitoring system comprising:
a flow rate monitor for monitoring a flow rate of a moving medium, comprising:
a pendulum for being suspended in the medium;
a first storage unit configured for storing an angle threshold value;
a monitoring unit configured for detecting angular movement of the pendulum caused by movement of the moving medium, sensing an angle of the angular movement of the pendulum, and generating a signal associated therewith;
a first control unit configured for obtaining the angle threshold value from the first storage unit, determining whether the angle detected by the monitoring unit is equal to or larger than the angle threshold value, the first control unit further configured for generating a warning signal if the angle detected by the monitoring unit is equal to or larger than the angle threshold value; and
a wireless transmitting unit configured for transmitting the warning signal;
an alarm configured for receiving the warning signal and performing a warning alarm in response to the warning signal.

2. The monitoring system as recited in claim 1, wherein the alarm comprising:
a second storage configured for storing a plurality of audio warning files;
a wireless receiving unit configured for receiving the warning signal transmitted by the wireless transmitting unit;
a sound output unit; and
a second control unit configured for obtaining one of the plurality of warning audio files in response to the warning signal, and controlling the sound output unit to play the obtained audio warning file.

3. The monitoring system as recited in claim 2, wherein the alarm further comprises a warning light emitter, the second control unit further configured for controlling the warning light emitter to emit the warning light in response to the received the warning signal.

4. A flow rate monitor for monitoring a flow rate of a moving medium, comprising:
a pendulum for being suspended in the medium;
a first storage unit configured for storing an angle threshold value;
a monitoring unit configured for detecting angular movement of the pendulum caused by movement of the moving medium, sensing an angle of the angular movement of the pendulum, and generating a signal associated therewith;
a first control unit configured for obtaining the angle threshold value from the first storage unit, determining whether the angle detected by the monitoring unit is equal to or larger than the angle threshold value, the first control unit further configured for generating a warning signal if the angle detected by the monitoring unit is equal to or larger than the angle threshold value; and
a wireless transmitting unit configured for transmitting the warning signal to an alarm to trigger the alarm to perform a warning alarm in response to the warning signal.

5. The flow rate monitor as recited in claim 4, wherein the monitoring unit is a gravity sensor.

6. A flow rate monitoring method comprising:
suspending a pendulum in a moving medium;
detecting an angle of an angular movement of the pendulum and determining a flow rate of the moving medium based on the detected angle and generating a signal associated therewith;
determining whether the angle detected is equal to or larger than an angel threshold value;
generating a warning signal if the angle detected is equal to or larger than the angle threshold value and transmitting the warning signal to an alarm; and
performing a warning alarm using the alarm in response to the warning signal.

7. The monitoring method as recited in claim 6, wherein the alarm emits warning light in response to the warning signal.
